(19) United States
(12) Patent Application Publication
(10) Pub. No.: US 2026/0368864 A1
(43) Pub. Date: Nov. 19, 2026

(54) SPATIO-TEMPORAL 3-D MESH SMOOTHING

(71) Applicants: Sony Group Corporation, Tokyo (JP); Sony Corporation of America, New York, NY (US)

(72) Inventor: Cheng Yi Liu, San Jose, CA (US)

(21) Appl. No.: 19/205,782

(22) Filed: May 12, 2025

(51) Int. Cl. G06T 5/70; G06T 17/20

(52) U.S. Cl. CPC G06T 5/70; G06T 17/205; G06T 2207/10016; G06T 2210/56

(57) ABSTRACT

Temporal mesh smoothing, including: receiving an initial mesh and a sequence of raw meshes; calculating an estimated mesh at a vertex and a particular time as most likely mesh that best explains the sequence of raw meshes and neighbors of the vertex given estimated meshes calculated at previous in time to the particular time; calculating a pure spatial part by calculating a conditional probability of the estimated mesh given a position of the vertex at the particular time; and calculating a spatio-temporal part by estimating the position of the vertex considering positions of previous neighboring vertices in time.

### BACKGROUND

### Field

The present disclosure relates to temporal mesh smoothing, and more specifically to spatio-temporal 3-D mesh smoothing.

### Background

Temporal smoothing on 3-D discrete point data may be used to reduce noise and highlight underlying trends in the sequence of 3-D point cloud data over time. This can improve the accuracy of 3-D object tracking, pose estimation, and other applications. Several techniques, including filtering, interpolation, and machine learning methods, can be employed for this purpose.

However, temporal smoothing using traditional filtering which focuses on smoothing the individual vertex positions without considering the mesh topology may lead to unexpected shape changes. Further, the motion learning may involve heavy computation and model size, which may be difficult to collect the training data fully covering all local shape dynamics.

### SUMMARY

The present disclosure provides for spatio-temporal mesh smoothing.

In one implementation, a method for temporal mesh smoothing is disclosed. The method includes: receiving an initial mesh and a sequence of raw meshes; calculating an estimated mesh at a vertex and a particular time as most likely mesh that best explains the sequence of raw meshes and neighbors of the vertex given estimated meshes calculated at previous in time to the particular time; calculating a pure spatial part by calculating a conditional probability of the estimated mesh given a position of the vertex at the particular time; and calculating a spatio-temporal part by estimating the position of the vertex considering positions of previous neighboring vertices in time.

In another implementation, a method for temporal mesh smoothing is disclosed. The method includes: receiving an initial mesh and a sequence of raw meshes; calculating an estimated mesh at a vertex and a particular time using the initial mesh and the sequence of raw meshes; calculating a pure spatial part by calculating a conditional probability of the estimated mesh given a position of the vertex at the particular time; calculating a spatio-temporal part; and executing an iterative form of a two-model smoother by maximizing the pure spatial part and the spatio-temporal part.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a diagram illustrating Equation [6] in accordance with one implementation of the present disclosure;

FIG. 2 is a flow diagram illustrating a temporal mesh smoothing method in accordance with one implementation of the present disclosure;

FIG. 3A is an illustration of an example sequence of raw meshes or point clouds which was input to a remesher in accordance with one implementation of the present disclosure;

FIG. 3B is an illustration of an example initial mesh

$$( {M}_{0}^{*} )$$

310 which was input to the remesher in accordance with one implementation of the present disclosure; and

FIG. 3C is an illustration of an example process of the remesher in accordance with one implementation of the present disclosure.

### DETAILED DESCRIPTION

As described above, temporal smoothing using traditional filtering which focuses on smoothing the individual vertex positions without considering the mesh topology may lead to unexpected shape changes. Accordingly, one of the objectives of the present disclosure is to smooth a sequence of meshes continuous in time, which are in the same topology, to reduce the temporal jittering of vertices for better visual quality.

Certain implementations of the present disclosure include: 3-D remeshing of each single frame, which applies any remeshing methods, to wrap the sequence of raw meshes in time into an identical mesh topology (i.e., the same number of vertices and the same surface definitions); and using a two-model temporal smoother to combine a pure spatial model with a spatio-temporal model to perform smoothing on each vertex in each mesh. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In contrast to other temporal smoothing methods working on temporal positional sequence of each point, implementations of the present disclosure assign the temporal smoothing problem as a local shape spatio-temporal stabilization problem. That is, implementations of the present disclosure not only smooth trajectory of each vertex in time but keep its neighborhood on the mesh highly consistent with the shape before smoothing. More specifically, a temporal mesh smoothing method, which combines a remesher, a spatial term, and a spatio-temporal term, is proposed. In particular, the spatial term keeps each smoothed vertex close to the position calculated by remeshing, and the spatio-temporal term stimulates [I CHANGED TERM “ENCOURAGES” TO “STIMULATES”? OK? OR OTHER MEANING?] each smoothed vertex having the similar positional dynamics as its neighboring vertices on the predefined mesh topology.

In one implementation, solving the temporal mesh smoothing includes solving the following equation:

$${v}_{i , t}^{*} = {max}_{{v}_{i , t}} p ( {v}_{i , t} \vert {O}_{t} , {\tilde{M}}_{t} , {M}_{{t}^{-}}^{*} , N ( {v}_{i} ) ) \qquad [ 1 ]$$

wherein,
v_{i,t(3×1)}=unknown smoothed 3D position of vertex i at time t,
Oₜ=the observation data at time t for remeshing, e.g.: a raw mesh or a point cloud,
\tilde{M}ₜ=estimated mesh at time t by the remeshing pipeline,
\tilde{v}_{i,t}∈\tilde{M}ₜ=estimated 3D position of vertex i at time t by the remeshing pipeline,

$${M}_{{t}^{-}}^{*}$$

=one to multiple smoothed meshes before time t,

$${v}_{i , t - 1}^{*} ϵ {M}_{t - 1}^{*}$$

=smoothed 3D position of vertex i at time t−1,
N(vᵢ)≡{∀vⱼ∈e_{i,j}∈M}=connected 3D vertex neighbors of vertex i on the mesh M,
n=|N(vᵢ)|=number of the connected 3D vertex neighbors of vertex i,

$$p ( {v}_{i , t} \vert {O}_{t} , {\tilde{M}}_{t} , {M}_{{t}^{-}}^{*} , N ( {v}_{i} ) ) = \frac{p ( {\tilde{M}}_{t} \vert {v}_{i , t} , {O}_{t} , {M}_{{t}^{-}}^{*} , N ( {v}_{i} ) ) p ( {v}_{i , t} \vert {O}_{i} , {M}_{{t}^{-}}^{*} , N ( {v}_{i} ) )}{p ( {\tilde{M}}_{i , t} \vert {O}_{t} , {M}_{{t}^{-}}^{*} , N ( {v}_{i} ) )} , and$$

$$p ( {\tilde{M}}_{i , t} \vert {O}_{t} , {M}_{{t}^{-}}^{*} , N ( {v}_{i} ) )$$

~ constant, given the deterministic remeshing result \tilde{M}_{i,t}.

In one implementation, solving the temporal mesh smoothing also includes separating the pure spatial part and the spatio-temporal part as follows:

$$p ( {v}_{i , t} \vert {O}_{t} , {\tilde{M}}_{t} , {M}_{{t}^{-}}^{*} , N ( {v}_{i} ) ) ∝ p ( {\tilde{M}}_{t} \vert {v}_{i , t} , {O}_{t} , {M}_{{t}^{-}}^{*} , N ( {v}_{i} ) ) p ( {v}_{i , t} \vert {O}_{t} , {M}_{{t}^{-}}^{*} , N ( {v}_{i} ) ) , \qquad [ 2 ]$$

wherein,

$$p ( {\tilde{M}}_{t} \vert {v}_{i , t} , {O}_{t} , {M}_{{t}^{-}}^{*} , N ( {v}_{i} ) ) ∝ {p}_{s} ( {\tilde{M}}_{t} \vert {v}_{i , t} ) \qquad [ 3 ]$$

is the pure spatial part, and

$$p ( {v}_{i , t} \vert {O}_{t} , {M}_{{t}^{-}}^{*} , N ( {v}_{i} ) ) \approx {p}_{t} ( {v}_{i , t} \vert {\tilde{M}}_{t} , {M}_{{t}^{-}}^{*} , N ( {v}_{i} ) ) \qquad [ 4 ]$$

is the spatio-temporal part.

Regarding the pure spatial part, pₛ(\tilde{M}ₜ|v_{i,t}) is inversely proportional to the distance between v_{i,t} and \tilde{M}ₜ. Thus, the goal is to keep v_{i,t} as close to \tilde{M}ₜ as possible which increases parameter

$$p ( {\tilde{M}}_{t} \vert {v}_{i , t} , {O}_{t} , {M}_{{t}^{-}}^{*} , N ( {v}_{i} ) ) .$$

Regarding the spatio-temporal part, term

$$p ( {v}_{i , t} \vert {O}_{t} , {M}_{{t}^{-}}^{*} , N ( {v}_{i} ) )$$

suggests the estimation of v_{i,t} considering the previous (temporal) neighboring vertices' positions on the meshes (spatial). Specifically, the neighborhood shape centered at v_{i,t} on

$${M}_{t}^{*}$$

should change smoothly along the mesh series

$${M}_{{t}^{-}}^{*}$$

to suppress the singular fluctuation of v_{i,t} in time. In the conditional term, \tilde{M}ₜ may be used as a surrogate of Oₜ due to the joint Oₜ,

$${M}_{{t}^{-}}^{*} ,$$

and N(vᵢ), because \tilde{M}ₜ approximates Oₜ in the same mesh topology on which N(vᵢ) and

$${M}_{{t}^{-}}^{*}$$

are defined to make

$$p ( {v}_{i , t} \vert {O}_{t} , {M}_{{t}^{-}}^{*} , N ( {v}_{i} ) ) \approx {p}_{t} ( {v}_{i , t} \vert {\tilde{M}}_{t} , {M}_{{t}^{-}}^{*} , N ( {v}_{i} ) ) .$$

Accordingly, the two-model smoother output may be calculated as maximization of the pure spatial part pₛ(\tilde{M}ₜ|v_{i,t}) and the spatio-temporal part

$${p}_{t} ( {v}_{i , t} \vert {\tilde{M}}_{t} , {M}_{{t}^{-}}^{*} , N ( {v}_{i} ) )$$

as follows:

$${v}_{i , t}^{*} = {max}_{{v}_{i , t}} {p}_{s} ( {\tilde{M}}_{t} \vert {v}_{i , t} ) {p}_{t} ( {v}_{i , t} \vert {\tilde{M}}_{t} , {M}_{{t}^{-}}^{*} , N ( {v}_{i} ) ) . \qquad [ 5 ]$$

In one implementation, the maximization step of Equation [5] is an iterative or single step analytical solution, depending on the design of the two models.

Example implementations for solving the temporal mesh smoothing of Equation [5] include solving the following steps:

$$p \approx {p}_{s} ( {\tilde{M}}_{t} \vert {v}_{i , t} ) {p}_{{}_{t}} ( {v}_{i , t} \vert {\tilde{M}}_{t} , {M}_{t - 1}^{*} , N ( {v}_{i} ) ) \approx {\prod }_{∀ {\tilde{v}}_{j , t} ∈ {\tilde{M}}_{t}} {p}_{{s}^{{}_{{}_{′}}}} ( {\tilde{v}}_{j , t} \vert {v}_{i , t} ) {p}_{{}_{t}} ( {v}_{i , t} \vert {\tilde{M}}_{t} , {M}_{t - 1}^{*} , N ( {v}_{i} ) ) ∝ {p}_{{s}^{′}} ( {\tilde{v}}_{i , t} \vert {v}_{i , t} ) {p}_{{}_{t}} ( {v}_{i , t} \vert {\tilde{M}}_{t} , {M}_{t - 1}^{*} , N ( {v}_{i} ) ) .$$

Let ∥(v_{i,t}−\tilde{v}_{i,t})∥=|γ~N(0,σ_{S})|,
wherein pₛ′(\tilde{v}_{i,t}|v_{i,t})≡p(∥(v_{i,t}−v_{i,t})∥).

Let

$${V}_{i , t} = \frac{1}{n} {\sum }_{∀ {v}_{j} ∈ N ( {v}_{i} )} ( {v}_{i , t} - {v}_{i , t - 1}^{*} ) - ( {\tilde{v}}_{j , t} - {v}_{j , t - 1}^{*} ) = {v}_{i , t} - ( {v}_{i , t - 1}^{*} + \frac{1}{n} {{\sum }_{∀ {v}_{j} ∈ N ( {v}_{i} )}}_{} {\tilde{v}}_{j , t} - {\tilde{v}}_{j , t - 1} ) , \\ and \\ {V}_{i , t}^{T} {V}_{i , t} = \vert Y ∼ N ( 0 , {σ}_{T} ) \vert ,$$

wherein pₜ≡p(V_{i,t}^{T}V_{i,t}).

Combining pₛ and pₜ from the above steps:

$$ln p ∝ - \frac{{( {v}_{i , t} - {\tilde{v}}_{i , t} )}^{T} ( {v}_{i , t} - {\tilde{v}}_{i , t} )}{2 {σ}_{S}^{2}} - \frac{{V}_{i , t}^{T} {V}_{i , t}}{2 {σ}_{T}^{2}} = L ,$$

$${max}_{{v}_{i , t}} p = {max}_{{v}_{i , t}} L ,$$

$$\frac{dL}{{dv}_{i , t}} = - \frac{( {v}_{i , t} - {\tilde{v}}_{i , t} )}{{σ}_{S}^{2}} - \frac{{v}_{i , t} - ( {v}_{i , t - 1}^{*} + \frac{1}{n} {\sum }_{∀ {v}_{j} ∈ N ( {v}_{i} )} {\tilde{v}}_{j , t} - {v}_{j , t - 1}^{*} )}{{σ}_{T}^{2}} = 0 ,$$

$${v}_{i , t}^{*} = \frac{{σ}_{S}^{2} {σ}_{T}^{2}}{{σ}_{S}^{2} + {σ}_{T}^{2}} ( \frac{{\tilde{v}}_{i , t}}{{σ}_{S}^{2}} + \frac{{v}_{i , t - 1}^{*} + \frac{1}{n} {\sum }_{∀ {v}_{j} ∈ N ( {v}_{i} )} {\tilde{v}}_{j , t} - {v}_{j , t - 1}^{*}}{{σ}_{T}^{2}} ) ,$$

$$wherein α = \frac{{σ}_{T}^{2}}{{σ}_{S}^{2} + {σ}_{T}^{2}} .$$

### Accordingly,

$${v}_{i , t}^{*} = α {\tilde{v}}_{i , t} + ( 1 - α ) ( {v}_{i , t - 1}^{*} + \frac{1}{n} {\sum }_{∀ {v}_{j} ∈ N ( {v}_{i} )} {\tilde{v}}_{j , t} - {v}_{j , t - 1}^{*} ) . \qquad [ 6 ]$$

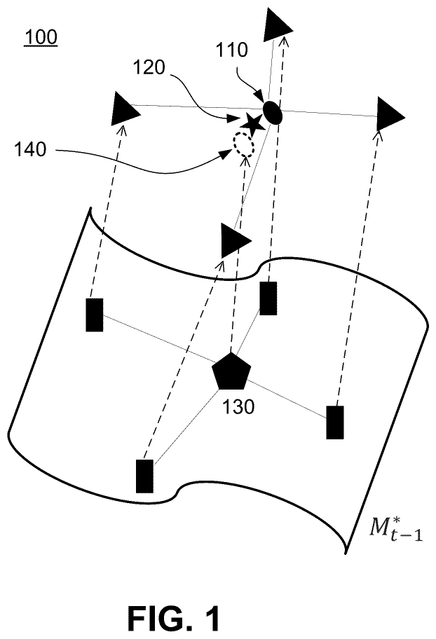

FIG. 1 is a diagram 100 illustrating Equation [6] in accordance with one implementation of the present disclosure. The illustrated implementation of FIG. 1 shows an estimated position of vertex at time t (\tilde{v}_{i,t}) 110, a smoothed position of vertex at time t

$$( {v}_{i , t}^{*} )$$

120, a smoothed position of vertex at time t−1

$$( {v}_{i , t - 1}^{*} )$$

130, and a smoothed position of vertex at time t−1 plus an average flow 140.

In the illustrated implementation of FIG. 1, the estimated 3D position of vertex i at time t by a meshing pipeline (\tilde{v}_{i,t}ϵ\tilde{M}ₜ) is represented by vertex ( [symbol] ) and four neighbors (▴), while the smoothed 3D position of vertex i at time t−1 by the meshing pipeline

$$( {v}_{i , t - 1}^{*} ϵ {M}_{t - 1}^{*} )$$

is represented by vertex ( [symbol] ) and four neighbors (▪) Further, term N(vᵢ) in Equation [6] may be expanded to k orders of neighbors on the mesh in the iterative form as follows:

$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} ) , \qquad [ 7 ]$$

$$wherein {v}_{i , t}^{0} = {\tilde{v}}_{i , t} and {v}_{i , t}^{*} = {v}_{i , t}^{k} .$$

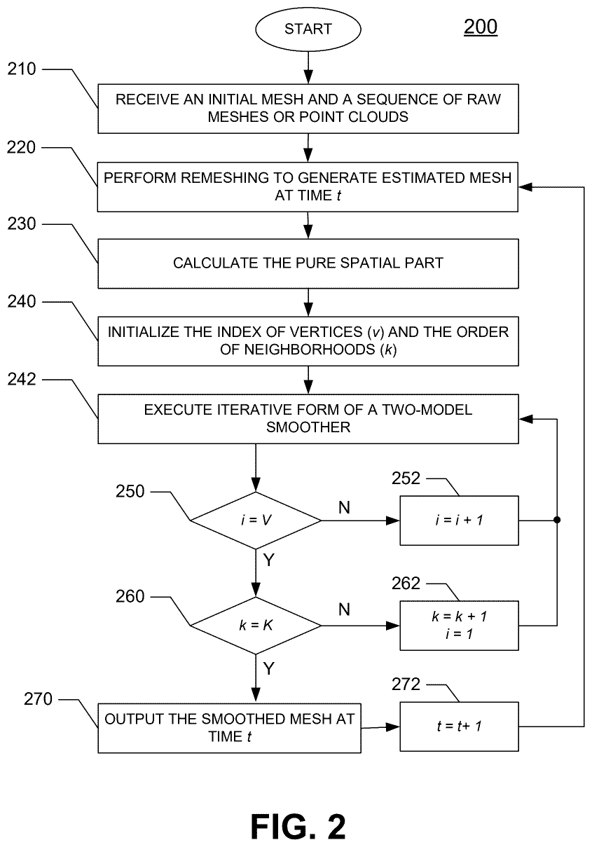

FIG. 2 is a flow diagram illustrating a temporal mesh smoothing method 200 in accordance with one implementation of the present disclosure. In the illustrated implementation of FIG. 2, an initial mesh and a sequence of raw meshes or point clouds are received, at step 210.

Remeshing is performed, at step 220, to generate the estimated mesh at time t (\tilde{M}ₜ). In one implementation, the estimated mesh at time t may be calculated, at step 220, as:

$${\tilde{M}}_{t} = {max}_{{M}_{t}} p ( {M}_{t} \vert {O}_{t} , {M}_{{t}^{-}}^{*} , N ( {v}_{i} ) ) , \qquad [ 8 ]$$

wherein
   Oₜ=observation data at time t,
   Mₜ=maximum a posteriori estimation of the mesh at time t, given Oₜ,

$${M}_{{t}^{-}}^{*}$$

=past Smoothed meshes before time t,
N(vᵢ)=connected vertex neighbors of vertex i.
   Thus, in Equation [8], the estimated mesh (\tilde{M}ₜ) is calculated by the remesher as the most likely mesh that best explains the observation data (e.g., raw meshes or point clouds) and the vertex neighbors (N(vᵢ)), given the history of the smoothed meshes

$$( {M}_{{t}^{-}}^{*} ) .$$

In one implementation of Equation [8],

$${M}_{t - 1}^{*}$$

of term

$${M}_{{t}^{-}}^{*}$$

is used as an initial mesh or as a constraint in the remesher.

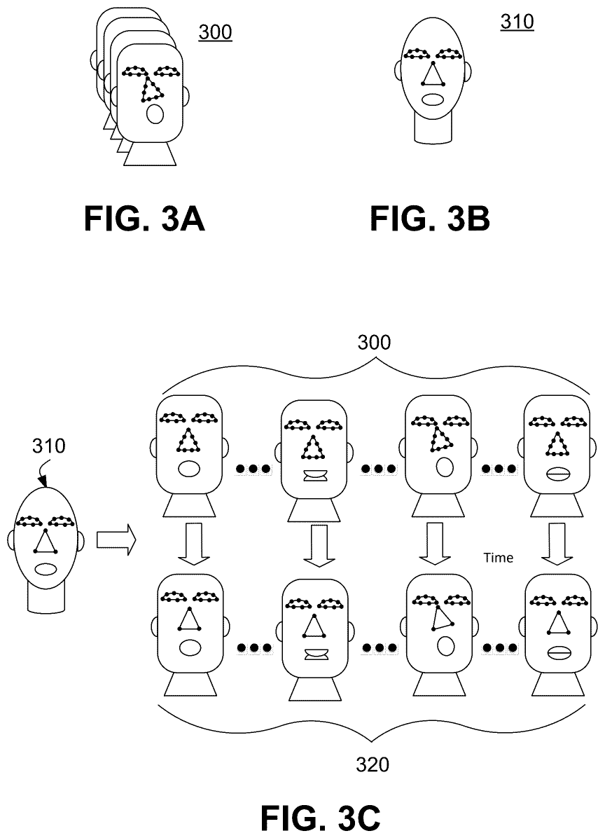

FIG. 3A is an illustration of an example sequence of raw meshes or point clouds 300 which was input to a remesher (at step 210) in accordance with one implementation of the present disclosure.

FIG. 3B is an illustration of an example initial mesh

$$( {M}_{0}^{*} )$$

310 which was input to the remesher (at step 210) in accordance with one implementation of the present disclosure.

FIG. 3C is an illustration of an example process of the remesher (at step 220) in accordance with one implementation of the present disclosure. FIG. 3C shows that the remesher receives the initial mesh 310 and the sequence of raw meshes or point clouds 300 to generate a sequence of estimated meshes (\tilde{M}ₜ) 320. In the illustrated implementation of FIG. 3C, the initial mesh 310 is used as a template mesh to fit to the sequence of raw meshes 300 (which are random and inconsistent) to generate the sequence of estimated meshes 320.

Referring back to the illustrated implementation of FIG. 2, the estimated mesh (\tilde{M}ₜ) calculated by the remesher is then used to calculate, at step 230, the pure spatial part pₛ(\tilde{M}ₜ|v_{i,t}), as shown in Equation [3]. In one implementation, the pure spatial part represents the conditional probability of the estimated mesh (\tilde{M}ₜ) given unknown position of vertex i at t (v_{i,t}). That is, the pure spatial part represents the probability of \tilde{M}ₜ occurring knowing that v_{i,t} has already happened. In general, pₛ(\tilde{M}ₜ|v_{i,t}) is inversely proportional to the distance between v_{i,t} and \tilde{M}ₜ. Thus, the goal in step 230 is to keep v_{i,t} as close to \tilde{M}ₜ as possible, such that

$$p ( {\tilde{M}}_{t} \vert {v}_{i , t} , {O}_{t} , {M}_{{t}^{-}}^{*} , N ( {v}_{i} ) )$$

is still high. In one implementation, the two-model smoother output

$${v}_{i , t}^{*} = {max}_{{v}_{i , t}} {p}_{s} ( {\tilde{M}}_{t} \vert {v}_{i , t} ) {p}_{t} ( {v}_{i , t} \vert {\tilde{M}}_{t} , {M}_{{t}^{-}}^{*} , N ( {v}_{i} ) )$$

is calculated as maximization of the pure spatial part pₛ(Mₜ|v_{i,t}) and the spatio-temporal part

$${p}_{{}_{t}} ( {v}_{i , t} \vert {\tilde{M}}_{t} , {M}_{{t}^{-}}^{*} , N ( {v}_{i} ) ) .$$

In one implementation, the two-model smoother output shown above as maximization of the pure spatial part and the spatio-temporal part may be implemented in an iterative form to k orders of neighbors on the mesh as shown in Equation [7]. Thus, at step 240, the index of vertices (v) and the order of neighborhoods (k) are initialized

$$( i . e . , {v}_{i , t}^{0} = {\tilde{v}}_{i , t} , 1 \leq i \leq V and k = 1 , i = 1 ) .$$

Then, the iterative form of the two-model smoother implementation as shown (Equation 7)

$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} )$$

is executed, at step 242.

In one implementation, the index of vertices is checked, at step 250, to determine whether the two-model smoother implementation has been executed for all vertices. If so, the order of neighborhoods is checked, at step 260, to determine whether the two-model smoother implementation has been executed for all neighborhoods. Otherwise, if the two-model smoother implementation has not been executed for all vertices (as determined in step 250), then the index of vertices is incremented, at step 252, and the two-model smoother implementation is executed again, at step 242. If it is determined, at step 260, that the two-model smoother implementation has been executed for all neighborhoods, then the smoothed mesh at time t

$$( {M}_{t}^{*} )$$

is output, at step 270. At step 272, the time is incremented (i.e., t=t+1), and the method 200 is repeated with the remeshing step at 220. Otherwise, if the two-model smoother implementation has not been executed for all neighborhoods (as determined in step 260), then the order of neighborhoods is incremented, and the index of vertices is set to 1, at step 262, and the two-model smoother implementation is executed again, at step 242.

In combining pₛ and pₜ to generate Equation [6], term α was set to

$$α = \frac{{σ}_{T}^{2}}{{σ}_{S}^{2} + {σ}_{T}^{2}} .$$

In another implementation, the time- and vertex-variant σ_{S}s and σ_{T}s are introduced into

$${α}_{i , t} = \frac{{σ}_{T , i , t}^{2}}{{σ}_{S , i , t}^{2} + {σ}_{T , i , t}^{2}}$$

so that Equation [6] is alternatively expressed as:

$${v}_{i , t}^{*} = {α}_{i , t} {\tilde{v}}_{i , t} + ( 1 - {α}_{i , t} ) ( {v}_{i , t - 1}^{*} + \frac{1}{n} {\sum }_{∀ {v}_{j} ∈ N ( {v}_{i} )} {\tilde{v}}_{j , t} - {v}_{j , t - 1}^{*} ) . \qquad [ 9 ]$$

In this implementation, the sliding temporal window technique is used to calculate σ_{S,i,t} and σ_{T,i,t} to continuously update σ_{s,i,t} and σ_{T,i,t} according to the statistics of the following variables in the current temporal window,

$${v}_{i , \cdot }^{*} - {\tilde{v}}_{i , \cdot }$$

and Vᵢ; ^{T}Vᵢ; wherein

$${V}_{i ,} . = \frac{1}{n} {\sum }_{∀ {v}_{j} ∈ N ( {v}_{i} )} ( {v}_{i , \cdot }^{*} - {v}_{i , \cdot - 1}^{*} ) - ( {\tilde{v}}_{j , t} - {v}_{j , \cdot - 1}^{*} ) . \qquad [ 10 ]$$

In one implementation, some preset σ_{S,i,t}s is used at different mesh regions according to the learned shape dynamics of the subject.

The advantages of the present implementations include:
(a) the proposed temporal smoothing method explicitly considers the underlying mesh topology, which may reduce vertex jittering (1) without compromising the mesh accuracy, (2) without distorting much shape properties, which could be subject- and location-specific and constructed by the processing steps before the smoother, and (3) possibly reduce the noises and achieve higher mesh accuracy than remeshing alone;
(b) the method is simple and light weight compared to other learning-based methods, and is directly applicable to online mesh streaming without any offline computations;
(c) the two models are independent from the remeshing method and does not need to be trained together, and can be tuned independently; and
(d) the choices of the spatio-temporal model and the pure spatial model are highly flexible and not limited to any of the above-disclosed implementations.

Accordingly, the above-disclosed implementations may be applied to any 4-D mesh data including: (a) digital characters/Metaverse such as the talking head animation for TV programs or the virtual front desk, augmented reality (AR)/virtual reality (VR)/extended reality (XR) video generation for commercials, games, or movies; (b) mesh compression such as a mesh smoother, which reduces the temporal high frequency noises and is beneficial to any mesh compressions to achieve a smaller code size; and (c) mesh streaming to be applied before or after the transmission for stable visualization.

In a particular implementation, a method for temporal mesh smoothing is disclosed. The method includes: receiving an initial mesh and a sequence of raw meshes; calculating an estimated mesh at a vertex and a particular time as most likely mesh that best explains the sequence of raw meshes and neighbors of the vertex given estimated meshes calculated at previous in time to the particular time; calculating a pure spatial part by calculating a conditional probability of the estimated mesh given a position of the vertex at the particular time; and calculating a spatio-temporal part by estimating the position of the vertex considering positions of previous neighboring vertices in time.

In one implementation, the method further includes using a remesher to calculate the estimated mesh at the vertex and the particular time. In one implementation, the remesher uses the initial mesh as a template mesh to fit to the sequence of raw meshes to generate the sequence of estimated meshes. In one implementation, calculating the estimated mesh at the vertex and the particular time includes expressing the estimated mesh as

$${\tilde{M}}_{t} = {max}_{{M}_{t}} {p ( {M}_{t} \vert {O}_{t} , {M}_{{t}^{-}}^{*} , N ( {v}_{i} ) )}_{,}$$

wherein Oₜ=observation data at the particular time, Mₜ=maximum a posteriori estimation of the estimated mesh at the particular time given Oₜ,

$${M}_{{t}^{-}}^{*}$$

=past smoothed meshes before the particular time, and N(vᵢ)=connected vertex neighbors of the vertex. In one implementation, calculating the pure spatial part includes the position of the vertex as close to the estimated mesh as possible. In one implementation, the method further includes executing an iterative form of a two-model smoother by maximizing the pure spatial part and the spatio-temporal part. In one implementation, the iterative form of the two-model smoother is expressed as

$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} ) .$$

In one implementation, the iterative form of a two-model smoother is executed for all vertices and for all neighborhoods. In one implementation, estimating the position of the vertex considering positions of previous neighboring vertices in time includes smoothly changing shape of a neighborhood formed by the neighbors of the vertex along the estimated meshes calculated at previous in time to the particular time.

In another particular implementation, a method for temporal mesh smoothing is disclosed. The method includes: receiving an initial mesh and a sequence of raw meshes; calculating an estimated mesh at a vertex and a particular time using the initial mesh and the sequence of raw meshes; calculating a pure spatial part by calculating a conditional probability of the estimated mesh given a position of the vertex at the particular time; calculating a spatio-temporal part; and executing an iterative form of a two-model smoother by maximizing the pure spatial part and the spatio-temporal part.

In one implementation, calculating the estimated mesh includes calculating the estimated mesh as most likely mesh that best explains the sequence of raw meshes and neighbors of the vertex given estimated meshes calculated at previous in time to the particular time. In one implementation, calculating the spatio-temporal part includes estimating the position of the vertex considering positions of previous neighboring vertices in time. In one implementation, the iterative form of the two-model smoother is expressed as

$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} ) .$$

In one implementation, the iterative form of a two-model smoother is executed for all vertices and for all neighborhoods. In one implementation, the temporal mesh smoothing is applied to digital characters. In one implementation, the digital characters comprise a talking head animation for TV programs or virtual front desks. In one implementation, the temporal mesh smoothing is applied to one of augmented-reality (AR), virtual-reality (VR), or extended-reality (XR) video generation. In one implementation, the video generation is made for commercials, games, or movies.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the application and design constraints imposed on the overall system. Skilled persons can implement the described functionality in varying ways for each application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for temporal mesh smoothing, comprising:
receiving an initial mesh and a sequence of raw meshes;
calculating an estimated mesh at a vertex and a particular time as most likely mesh that best explains the sequence of raw meshes and neighbors of the vertex given estimated meshes calculated at previous in time to the particular time;
calculating a pure spatial part by calculating a conditional probability of the estimated mesh given a position of the vertex at the particular time; and
calculating a spatio-temporal part by estimating the position of the vertex considering positions of previous neighboring vertices in time.

2. The method of claim 1, further comprising
using a remesher to calculate the estimated mesh at the vertex and the particular time.

3. The method of claim 2, wherein the remesher uses the initial mesh as a template mesh to fit to the sequence of raw meshes to generate the sequence of estimated meshes.

4. The method of claim 1, wherein calculating the estimated mesh at the vertex and the particular time includes expressing the estimated mesh as
$${\tilde{M}}_{t} = {max}_{{M}_{t}} {p ( {M}_{t} \vert {O}_{t} , {M}_{{t}^{-}}^{*} , N ( {v}_{i} ) )}_{,}$$
Oₜ=observation data at the particular time,
Mₜ=maximum a posteriori estimation of the estimated mesh at the particular time given Oₜ,
$${M}_{{t}^{-}}^{*}$$
=past smoothed meshes before the particular time,
N(vᵢ)=connected vertex neighbors of the vertex.

5. The method of claim 1, wherein calculating the pure spatial part includes the position of the vertex as close to the estimated mesh as possible.

6. The method of claim 1, further comprising
executing an iterative form of a two-model smoother by maximizing the pure spatial part and the spatio-temporal part.

7. The method of claim 6, wherein the iterative form of the two-model smoother is expressed as
$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} ) .$$

8. The method of claim 6, wherein the iterative form of the two-model smoother includes time- and vertex-variant σ_{S}s and σ_{T}s and is expressed as:
$${v}_{i , t}^{*} = {α}_{i , t} {\tilde{v}}_{i , t} + ( 1 - {α}_{i , t} ) ( {v}_{i , t - 1}^{*} + \frac{1}{n} {\sum }_{∀ {v}_{j} ∈ N ( {v}_{i} )} {\tilde{v}}_{j , t} - {v}_{j , t - 1}^{*} ) .$$

9. The method of claim 6, wherein the iterative form of a two-model smoother is executed for all vertices and for all neighborhoods.

10. The method of claim 1, wherein estimating the position of the vertex considering positions of previous neighboring vertices in time comprises
smoothly changing shape of a neighborhood formed by the neighbors of the vertex along the estimated meshes calculated at previous in time to the particular time.

11. A method for temporal mesh smoothing, comprising:
receiving an initial mesh and a sequence of raw meshes;
calculating an estimated mesh at a vertex and a particular time using the initial mesh and the sequence of raw meshes;
calculating a pure spatial part by calculating a conditional probability of the estimated mesh given a position of the vertex at the particular time;
calculating a spatio-temporal part; and
executing an iterative form of a two-model smoother by maximizing the pure spatial part and the spatio-temporal part.

12. The method of claim 11, wherein calculating the estimated mesh comprises
calculating the estimated mesh as most likely mesh that best explains the sequence of raw meshes and neighbors of the vertex given estimated meshes calculated at previous in time to the particular time.

13. The method of claim 11, wherein calculating the spatio-temporal part comprises
estimating the position of the vertex considering positions of previous neighboring vertices in time.

14. The method of claim 11, wherein the iterative form of the two-model smoother is expressed as
$${v}_{i , t}^{k} = α {v}_{i , t}^{k - 1} + ( 1 - α ) ( {v}_{i , t - 1}^{*} + \frac{1}{n} {\sum }_{∀ {v}_{j} ∈ N ( {v}_{i} )} {v}_{j , t - 1}^{k - 1} - {v}_{j , t - 1}^{*} ) .$$

15. The method of claim 11, wherein the iterative form of the two-model smoother includes time- and vertex-variant σ_{S}s and σ_{T}s and is expressed as:
$${v}_{i , t}^{*} = {α}_{i , t} {\tilde{v}}_{i , t} + ( 1 - {α}_{i , t} ) ( {v}_{i , t - 1}^{*} + \frac{1}{n} {\sum }_{∀ {v}_{j} ∈ N ( {v}_{i} )} {\tilde{v}}_{j , t} - {v}_{j , t - 1}^{*} ) .$$

16. The method of claim 11, wherein the iterative form of a two-model smoother is executed for all vertices and for all neighborhoods.

17. The method of claim 11, wherein the temporal mesh smoothing is applied to digital characters.

18. The method of claim 17, wherein the digital characters comprise a talking head animation for TV programs or virtual front desks.

19. The method of claim 11, wherein the temporal mesh smoothing is applied to one of augmented reality (AR), virtual reality (VR), or extended reality (XR) video generation.

20. The method of claim 19, wherein the video generation is made for commercials, games, or movies.
